(19) United States
(12) Patent Application Publication
(10) Pub. No.: US 2018/0194150 A1
(43) Pub. Date: Jul. 12, 2018

(54) HYGIENIC PRINTER CABINET

(71) Applicant: VIDEOJET TECHNOLOGIES INC., Wood Dale, IL (US)

(72) Inventors: Robert SMITH, Northamptonshire (GB); Salhadin OMER, Cambridgeshire (GB)

(21) Appl. No.: 15/736,679

(22) PCT Filed: Jun. 14, 2016
(86) PCT No.: PCT/US2016/037327

§ 371 Date: Dec. 14, 2017

(30) Foreign Application Priority Data
Jun. 15, 2015 (GB) 1510463.1

(51) Int. Cl. B41J 29/13; B41J 11/56; B41J 15/04; B41J 29/04

(52) U.S. Cl. CPC B41J 29/13; B41J 11/56; B41J 2202/19; B41J 29/04; B41J 2202/20; B41J 15/042

(57) ABSTRACT

An inkjet printer cabinet for use in a hygienic environment includes a housing formed by a base, a top and one or more walls extending between the base and the top. The housing defines an interior configured for receipt of components of an inkjet printer. The housing defines one or more apertures, each aperture providing access to at least one of the components via the aperture. The housing incorporates one or more features adapted to reduce at least one of the accumulation of unwanted matter on a surface of the housing and the accumulation of unwanted matter within the interior of the housing.

### BACKGROUND

The present invention relates to ink jet printing and more particularly to a cabinet for an ink jet printer such as a continuous ink jet printer.

In ink jet printing systems the print is made up of individual droplets of ink generated at a nozzle and propelled towards a substrate. There are two principal systems: drop on demand where ink droplets for printing are generated as and when required; and continuous ink jet printing in which droplets are continuously produced and only selected ones are directed towards the substrate, the others being recirculated to an ink supply.

Continuous ink jet printers supply pressurized ink to a print head drop generator where a continuous stream of ink emanating from a nozzle is broken up into individual regular drops by, for example, an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate).

In continuous ink jet printing a character is printed from a matrix including a regular array of potential drop positions. Each matrix includes a plurality of columns (strokes), each being defined by a line including a plurality of potential drop positions (e.g. seven) determined by the charge applied to the drops. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a reservoir or tank via a filter and delivers it under pressure to the print head. As ink is consumed the reservoir is refilled as necessary from a replaceable ink cartridge that is releasably connected to the reservoir by a supply conduit. The ink is fed from the reservoir via a flexible delivery conduit to the print head. The unused ink drops captured by the gutter are recirculated to the reservoir via a return conduit by a pump. The flow of ink in each of the conduits is generally controlled by solenoid valves and/or other like components.

As the ink circulates through the system, there is a tendency for it to thicken as a result of solvent evaporation, particularly in relation to the recirculated ink that has been exposed to air in its passage between the nozzle and the gutter. To compensate for this, “make-up” solvent is added to the ink as required from a replaceable ink cartridge so as to maintain the ink viscosity within desired limits. This solvent may also be used for flushing components of the print head, such as the nozzle and the gutter, in a cleaning cycle.

The ink and solvent cartridges are filled with a predetermined quantity of fluid and generally releasably connected to the reservoir of the ink supply system so that the reservoir can be intermittently topped-up by drawing ink and/or solvent from the cartridges as required. To ensure the cartridges are brought into correct registration with supply conduits, the cartridges are typically connected to the ink supply system via a docking station including a cartridge holder. When the cartridges are correctly docked fluid communication with an outlet port of the cartridge is ensured.

### BRIEF SUMMARY

It is important from the manufacturer's perspective that the ink jet printer consumes only ink (or solvent) of the correct type and quality. If a cartridge containing the wrong ink is used the printing quality can be compromised and, in extreme cases, printer failure may be caused. It is therefore known, in some inkjet printers, to provide the cartridge with an externally machine readable label (e.g. a bar code) carrying information regarding the fluid contained within the cartridge. The label is swiped past a reader associated with the control system of the printer before the cartridge is installed and only when the control system of the printer has read the information on the label and verified that the ink is suitable for operation with the printer does it allow ink or solvent to be drawn from the cartridge.

Continuous ink jet printers may be used in food preparation environments. Furthermore, along with other apparatus in such food preparation environments, the ink jet printer may be cleaned periodically by being hosed down to ensure food hygiene standards are met. For example, when a production line is used for the preparation of more than one foodstuff all equipment on the production line (which may include an ink jet printer) may be hosed down between preparation of two different foods on the production line. This can reduce contamination of the second food by the first.

It is an object of the present invention, amongst others, to provide an improved or an alternative cabinet for an ink jet printer. It is a further object of the present invention to provide a cabinet for an ink jet printer that is particularly suitable for use in hygienic environments such as food production environments.

According to a first aspect of the present invention there is provided an inkjet printer cabinet for use in a hygienic environment, the cabinet including a housing formed by a base, a top and one or more walls extending between the base and the top, the housing defining an interior configured for receipt of components of an inkjet printer, the housing defining one or more apertures, the or each aperture providing access to at least one of the components via the aperture, the housing incorporating one or more features adapted to reduce at least one of the accumulation of unwanted matter on a surface of the housing and the accumulation of unwanted matter within the interior of the housing.

The one or more features adapted to reduce at least one of the accumulation of unwanted matter on a surface of the housing and the accumulation of unwanted matter within the interior of the housing make the inkjet printer cabinet of the first aspect of the invention particularly suitable for use in hygienic environments such as food production environments.

It will be appreciated that “a hygienic environment” may include any environment which it is desired to keep clean. Such environments include food preparation environments, medical or pharmaceutical environments (e.g. within hospitals) or the like.

The top may be disposed at a non-zero angle to the base. The top may be inclined relative to the base. An angle between a plane of the top and a plane of the base may be greater than 10°, for example greater than 15°, greater than 20°. An angle between a plane of the top and a plane of the base may be between 15° and 25°. In use, the base may be supported by a stand or the like and may be substantially horizontal. Since the top is disposed at a non-zero angle to the base, it will be not be horizontal in use. This reduces collection of matter (such as, for example, food debris from a production line) on the inkjet printer cabinet since such matter will tend to slide off the inclined surface formed by the top. Furthermore, the inclination of the top relative to base aids drainage of water or other cleaning fluids from the inkjet printer cabinet when it is being hosed down, preventing cleaning fluid (potentially containing food debris) from pooling on a surface of the cabinet.

The inkjet printer cabinet may include one or more handles, wherein the one or each handle is provided by a recess at an edge between the one or more walls and the base. The recess is for use as a handhold. A user can insert a hand into the recess when it is desired to lift the inkjet printer cabinet 16. Such an arrangement avoids the provision of any upwardly facing horizontal surfaces (as would be provided by an external handle) on which matter could collect or cleaning fluids could pool.

The inkjet printer cabinet may further include one or more doors, the or each door may be pivotally connected to the housing and movable about a pivot between at least a closed position wherein it blocks access to a corresponding one of the one or more apertures and an open position wherein the corresponding aperture is accessible.

The housing may be shaped such that the or each door is disposed at a non-zero angle to the base when disposed in its closed position. At least one door may be inclined relative to the base. An angle between a plane of the door (when closed) and a plane of the base may be greater than 50°, for example greater than 60°, for example greater than 70°. An angle between a plane of the door (when closed) and a plane of the base may be between 65° and 75°. In use, the base may be supported by a stand or table or the like and may be substantially horizontal. Since the door is disposed at a non-zero angle to the base, when closed it will be not be horizontal in use. This reduces collection of matter (such as, for example, food debris from a production line) on the inkjet printer cabinet since such matter will tend to slide off the inclined surface formed by the door. Furthermore, the inclination of the top relative to base aids drainage of water or other cleaning fluids from the inkjet printer cabinet when it is being hosed down, preventing cleaning fluid (potentially containing food debris) from pooling on a surface of the cabinet.

Each of the one or more doors may be provided with an internal hinge.

The internal hinge may be arranged such that the pivot of the door is disposed within a recess or a housing of the door.

The inkjet printer cabinet may further include a sealing member around a perimeter of the or each aperture, the sealing member for providing a seal between the housing and one or the one or more doors.

The inkjet printer cabinet may include two doors and may further include a sealing member provided on one or both of the two doors arranged to provide a seal between the two doors when they are both in their respective closed positions.

According to a second aspect of the invention there is provided an ink jet printer including the inkjet printer cabinet of the first aspect.

The ink jet printer may further include: a print head; an ink supply system; and a controller operable to provide control signals to the print head and the ink supply system so as to control the flow of ink and solvent through the inkjet printer, wherein the ink supply system and/or the controller is at least partially housed within the cabinet.

The ink jet printer may be a continuous inkjet printer.

Embodiments of the present invention will now be described, by way of example, with reference to the accompanying drawings, in which:

### BRIEF DESCRIPTION OF THE DRAWINGS

FIG. 1 is a schematic illustration of a continuous ink jet printer in accordance with an embodiment of the invention;

FIG. 2 is a schematic representation of the continuous ink jet printer of FIG. 1;

FIG. 3 is a perspective view of a cabinet according to an embodiment of the invention;

FIG. 4 is a side view of the cabinet shown in FIG. 3;

FIG. 5 is a perspective view of a housing that forms part of the cabinet shown in FIGS. 3 and 4;

FIG. 6 is a perspective view of a bracket that forms part of a hinge of the cabinet shown in FIGS. 3 and 4;

FIG. 7 is a perspective view of a lower door that forms part of the cabinet shown in FIGS. 3 and 4 and two hinges, each incorporating the bracket of FIG. 6;

FIG. 8A is a front view of a sealing member that forms part of the cabinet shown in FIGS. 3 and 4;

FIG. 8B is a cross sectional view of the sealing member shown in FIG. 8B along the line A-A;

FIG. 9 is a perspective view of a hinge of the cabinet shown in FIGS. 3 and 4;

FIG. 10 is a perspective view of an upper door that forms part of the cabinet shown in FIGS. 3 and 4 and two hinges as shown in FIG. 9;

FIG. 11A is a front view of another sealing member that forms part of the cabinet shown in FIGS. 3 and 4;

FIG. 11B is a cross sectional view of the sealing member shown in FIG. 11B along the line B-B;

FIG. 11C is a cross sectional view of the sealing member shown in FIG. 11B along the line A-A; and

FIG. 12 is a partial cross sectional view of a rear plate of the upper door shown in FIG. 10 through one of the two hinges.

### DETAILED DESCRIPTION

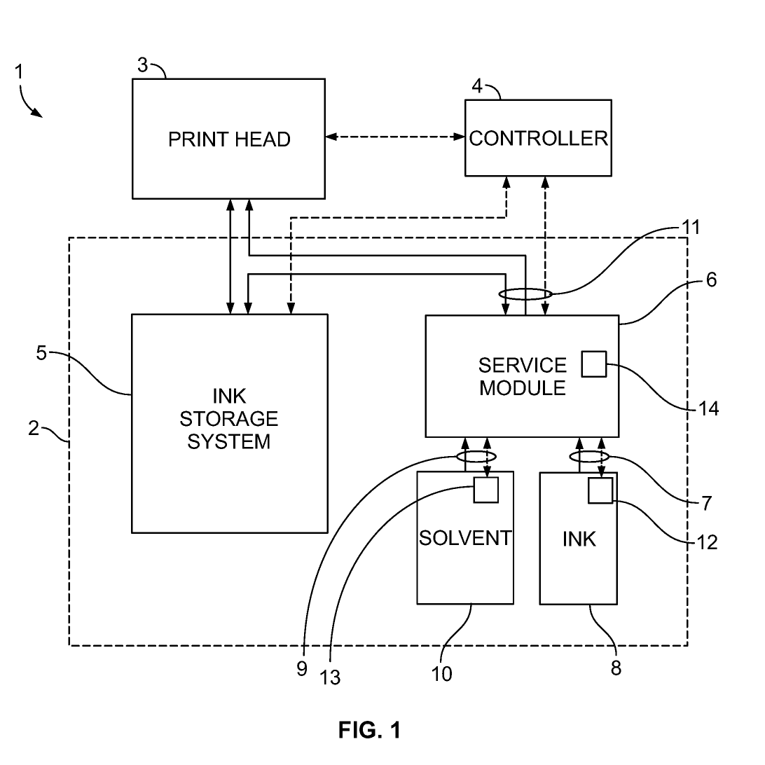

FIG. 1 schematically illustrates an inkjet printer 1. Inkjet printer 1 includes an ink supply system 2, a print head 3 and a controller 4. The ink supply system 2 includes an ink storage system 5 and a service module 6. In FIG. 1, fluid flow through the inkjet printer is illustrated schematically by solid arrows and control signals are illustrated schematically by dashed arrows. The service module 6 is configured for releasable engagement with inkjet printer 1 so that the module can be easily removed from the inkjet printer 1 for servicing or replacement. The service module 6 is therefore a removable module for an inkjet printer.

The service module 6 includes two cartridge connections for releasable engagement with a fluid cartridge. In particular, the service module 6 includes an ink cartridge connection 7 for releasable engagement with an ink cartridge 8 and a solvent cartridge connection 9 for releasable engagement with a solvent cartridge 10. The service module 6 further includes a printer connection 11 for releasable engagement with an inkjet printer. In use, the service module 6 forms part of inkjet printer 1 and it will be appreciated that in this context in the expression “for releasable engagement with an inkjet printer” the term “inkjet printer” is intended to mean those parts of the inkjet printer excluding the service module 6.

The printer connection 11 includes a plurality of fluid ports, each fluid port arranged to connect to a fluid pathway within the inkjet printer 1 to allow fluid to flow between the service module 6 and other parts of the inkjet printer 1, such as the ink storage system 5 and the print head 3. The printer connection 11 further includes an electrical connector arranged to engage with a corresponding connector on the inkjet printer 1.

Each of the ink and solvent cartridge connections 7, 9 includes a fluid connector for engaging an outlet of respective ink and solvent cartridges 8, 10 so as to allow fluid to flow from the cartridges 8, 10 into the service module 6. From the service module 6, ink and solvent can flow to the ink storage system 5 via the printer connection 11. In operation, ink from the ink cartridge 8 and solvent from the solvent cartridge 10 can be mixed within the ink storage system 5 so as to generate printing ink of a desired viscosity which is suitable for use in printing. This ink is supplied to the print head 3 and unused ink is returned from the print head 3 to the ink storage system 5. The service module 6 is also operable to provide a flow of solvent to the print head 3 via printer connection 11 for cleaning purposes.

The ink jet printer 1 is controlled by controller 4. Controller 4 receives signals from various sensors within the inkjet printer 1 and is operable to provide appropriate control signals to the ink supply system 2 and the print head 3 to control the flow of ink and solvent through the inkjet printer 1. The controller 4 may be any suitable device known in the art, and typically includes at least a processor and memory.

The ink cartridge 8 may be provided with an electronic data storage device 12 storing data relating to contained ink (e.g. type and quantity of ink). Similarly, the solvent cartridge 10 may be provided with an electronic data storage device 13 storing data relating to contained solvent (e.g. type and quantity of solvent). The service module 6 includes an electronic data storage device 14. Electronic data storage device 14 may store identification data (e.g. an identification code). Electronic data storage device 14 may also store other types of data, such as identification data relating to the type of ink and/or solvent that the service module 6 can be used with (or has previously been used with), a model number of the service module 6 or inkjet printer 1, a serial number, a manufacture date, an expiration date, a date first used in service, number of hours the service module 6 has been used in the inkjet printer 1, service life, and the like. Information stored on any one of the electronic data storage devices 12, 13, 14 may be stored in encrypted form. This may prevent any tampering of the data. The electronic data storage device 14 may include security data so that only suitable or recognized service modules 6 can be used with the inkjet printer 1. The electronic data storage device 14 may also include a writable data portion. The inkjet printer 1 may write to the electronic data storage device 14 to indicate that the service module 6 has reached the end of its service life, so that the service module can no longer be used in the inkjet printer 1 or any other printer.

The controller 4 is arranged to communicate with the electronic data storage devices 12, 13. This communication with the electronic data storage devices 12, 13 of cartridges 8, 10 is via the service module 6. Each of the ink and solvent cartridge connections 7, 9 includes an electrical contact arranged to contact a corresponding contact on the engaged ink or solvent cartridge 8, 10. The corresponding contact on the cartridges 8, 10 allows information to be read from and/or written to data storage devices 12, 13 respectively via the printer connection 11 of the service module 6.

For example, when the ink supply system 2 is first used, data from the electronic data storage device 12 and/or the electronic data storage device 13 is read to ascertain a type of ink and/or solvent being used. Subsequently, when a new ink cartridge or solvent cartridge is used within the printer 1, a check may be made by the controller 4 of data stored on respective electronic data storage devices 12, 13 of the ink cartridge 8 and the solvent cartridge 10 to ensure compatibility. In this way, when the ink supply system 2 is used with a particular type of ink, the controller 4 ensures that the printer 1 is operable (i.e. ensures that ink is allowed to flow from the ink cartridge 8 and/or that solvent is allowed to flow from the solvent cartridge 10) only if data associated with the ink cartridge 8 and/or solvent cartridge 10 as stored on the electronic data storage devices 12, 13 indicates compatibility.

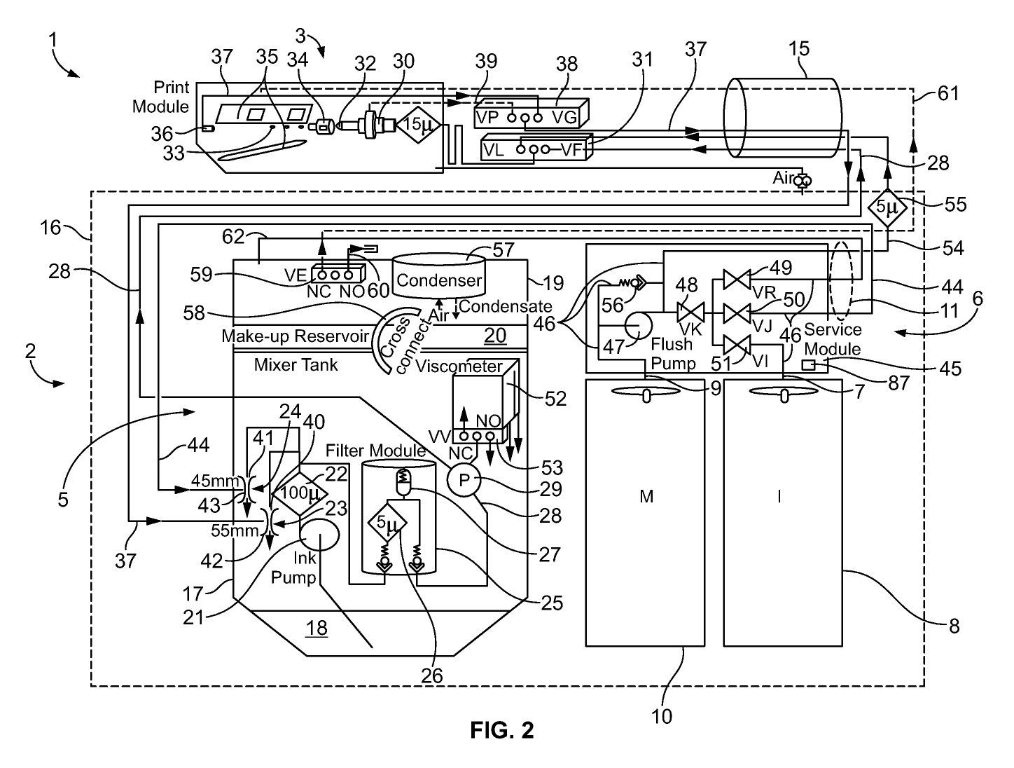

The ink jet printer 1, and particularly the ink supply system 2 is now described in further detail, with reference to FIG. 2. FIG. 2 schematically shows elements of the ink jet printer 1 of FIG. 1 in greater detail and, for clarity, the controller 4 and associated signals have been omitted.

In operation, ink is delivered under pressure from ink supply system 2 to print head 3 and back via flexible tubes which are bundled together with other fluid tubes and electrical wires (not shown) into what is referred to in the art as an “umbilical” conduit 15. The ink supply system 2 is located in a cabinet 16 according to an embodiment of the present invention and the print head 3 is disposed outside of the cabinet 16. The cabinet 16 is typically mounted on a stand.

The ink storage system 5 includes a mixer tank 17 for storage of a reservoir of ink 18 and a solvent tank 19 for storage of a reservoir of solvent 20. The mixer tank has a generally tapered lower portion within which the reservoir of ink 18 is disposed.

In operation, ink is drawn from the reservoir of ink 18 in mixer tank 17 by a system pump 21. The mixer tank 17 is topped up as necessary with ink and make-up solvent from replaceable ink and solvent cartridges 8, 10. Ink and solvent are transferred from the ink and solvent cartridges 8, 10 to the mixer tank 17 via the service module 6 as will be described further below.

It will be understood from the description that follows that the ink supply system 2 and the print head 3 include a number of flow control valves which are of the same general type: a dual coil solenoid-operated two-way flow control valve. The operation of each of the valves is governed by the controller 4.

Ink drawn from the mixer tank 17 is filtered first by a first (relatively coarse) filter 22 downstream of the system pump 21 and then is delivered selectively under pressure to two venturi pumps 23, 24 and a filter module 25. Filter module 25 includes a second, finer ink filter 26 and a fluid damper 27. Fluid damper 27 is of conventional configuration and removes pressure pulsations caused by the operation of the system pump 21. Ink is supplied through a feed line 28 to the print head 3 via a pressure transducer 29.

At the print head 3 the ink from the feed line 28 is supplied to a drop generator 30 via a first flow control valve 31. The drop generator 30 includes a nozzle 32 from which the pressurized ink is discharged and a piezoelectric oscillator (not shown) which creates pressure perturbations in the ink flow at a predetermined frequency and amplitude so as break up the ink stream into drops 33 of a regular size and spacing. The break up point is downstream of the nozzle 32 and generally coincides with a charge electrode 34 where a predetermined charge is applied to each drop 33. This charge determines the degree of deflection of the drop 33 as it passes a pair of deflection plates 35 between which a substantially constant electric field is maintained. Uncharged drops pass substantially undeflected to a gutter 36 from where they are recycled to the ink supply system 2 through return line 37 via a second flow control valve 38. Charged drops are projected towards a substrate (not shown) that moves past the print head 3. The position at which each drop 33 impinges on the substrate is determined by the amount of deflection of the drop and the speed of movement of the substrate.

To ensure effective operation of the drop generator 30 the temperature of the ink entering the print head 3 may be maintained at a desired level by a heater (not shown) before it passes to the first control valve 31. In instances where the printer is started up from rest it is desirable to allow ink to bleed through the nozzle 32 without being projected toward the gutter 36 or substrate. In such instances ink flows from the first control valve 31 to the nozzle 32 and then returns to the second control valve 38 via a bleed line 39, where it joins return line 37. The passage of the ink into the return line 37, whether it is the bleed flow or recycled unused ink captured by the gutter 36, is controlled by the second flow control valve 38. The returning ink is drawn back to the mixer tank 17 by venturi pump 23.

Venturi pumps 23, 24 are of known configuration and make use of the Bernoulli Principle whereby fluid flowing through a restriction in a conduit increases to a high velocity jet at the restriction and creates a low pressure area. If a side port is provided at the restriction this low pressure can be used to draw in and entrain a second fluid in a conduit connected to the side port. In this instance, the pressurized ink flows through a pair of conduits 40, 41 and back to the reservoir 18 in the mixer tank 17. Each conduit 40, 41 is provided with a side port 42, 43 at the venturi restriction. The increase in flow velocity of the ink creates a suction pressure at the side port 42, 43 and this serves to draw returning ink and/or solvent through return line 37 and a supply line 44 respectively.

As ink flows through the system and comes into contact with air in the mixer tank 17 and at the print head 3, a portion of its solvent content tends to evaporate. The ink supply system 2 is therefore operable to supply make-up solvent as required so as to maintain the viscosity of the ink within a predefined range suitable for use.

The service module 6 includes a body 45 defining a plurality of fluid conduits (shown schematically in FIG. 2 as lines 46). The service module 6 further includes a flush pump 47 and four valves 48, 49, 50, 51 which are arranged to selectively link two or more of the plurality of fluid conduits 46 so as to form one or more fluid pathways through the body 45. The flush pump 47 and the valves 48, 49, 50, 51 are controlled by the controller 4 by sending one or more control signals via the printer connection 11. Using appropriate control signals, the service module 6 can be disposed in a plurality of different configurations to allow ink or solvent to flow through the inkjet printer 1 in a plurality of different modes, as now described. In the following, it should be assumed that each of the four valves 48, 49, 50, 51 is closed unless stated otherwise.

In operation, ink from the ink cartridge 8 and solvent from the solvent cartridge 10 can be added to the mixer tank 17 as required so as to generate printing ink of a desired viscosity which is suitable for printing. This addition of ink and/or solvent to the mixer tank 17 uses venturi pump 24.

Mixer tank 17 is provided with a level sensor (not shown) that is operable to determine a level of ink in the mixer tank 17 and output a signal indicative thereof to controller 4. Ink is consumed during printing and therefore during normal operation the level of ink in the mixer tank 17 will fall over time. When the level of ink in the mixer tank falls below a lower threshold the controller 4 is operable to control the ink supply system 2 so as to add more ink to the mixer tank 17. Using suitable control signals, ink is drawn from the mixer tank 17 by system pump 21 and delivered under pressure to venturi pump 24 to create suction pressure at the side port 43. To add ink to the mixer tank 17, valves 50, 51 in the service module 6 are opened. Ink is drawn from ink cartridge 8 along supply line 44 under suction pressure from venturi pump 24. The ink discharges into the mixer tank 17, increasing the level. When the level of ink in the mixer tank 17 reaches an upper threshold the controller 4 is operable to stop the supply of ink to mixer tank 17. To achieve this, flow to venturi pump 24 is stopped and valves 50, 51 are closed.

Following such a process of topping up the level of ink in mixer tank 17, the controller 4 sends a signal to data storage device 12 on ink cartridge 8 indicative of the quantity of ink that has been transferred from the cartridge 8 to the mixer tank 17. A quantity of ink remaining in the ink cartridge 8 may be stored on the data storage device 12 and may be updated in response to the signal from the controller 4.

As explained above, as ink flows through the system and comes into contact with air in the mixer tank 17 and that the print head 3, a portion of its solvent content tends to evaporate. Periodically, the viscosity of the ink within the mixer tank 17 (or a quantity indicative thereof) is determined using a viscometer 52 disposed in mixer tank 17.

The viscometer 52 is periodically supplied with ink under pressure from system pump 21 via filter module 25. Flow of ink into the viscometer is controlled by control valve 53. Using control valve 53, a predetermined volume of ink is supplied to a chamber within viscometer 52 and then supply of ink to the viscometer 52 is stopped. Ink then drains out of the chamber under gravity. The rate at which the ink drains out of the chamber is dependent on the viscosity of the ink and is monitored using a plurality of electrodes disposed at different levels within the chamber. Signals from the plurality of electrodes are received by controller 4, which is operable to determine whether or not the viscosity of ink within the mixer tank 17 is within a desired operating range, defined by lower and upper threshold values.

If the viscosity is above the upper threshold value then solvent is added to the mixer tank 17 from solvent reservoir 20 in solvent tank 19 as now described. Ink is drawn from the mixer tank 17 and delivered under pressure to venturi pump 24 to create suction pressure at the side port 43. To add solvent, valves 49, 50 in the service module 6 are opened. Under suction pressure from the venturi pump 24, solvent is drawn from solvent reservoir 20 along line 62 to the service module 6 and back along supply line 44 to the mixer tank 17. The solvent discharges into the mixer tank 17, reducing the viscosity of the ink in reservoir 18.

The controller 4 may determine a quantity of solvent to add to the mixer tank 17 based on the determined viscosity of the ink. When a desired quantity of solvent has been added to the mixer tank 17, flow to the venturi pump 24 may be stopped and the valves 49, 50 are closed.

Once solvent has been added to the mixer tank 17, the viscometer 52 may be used again to determine the viscosity of ink. There may be a time delay between adding the solvent and re-checking the viscosity of the ink so as to allow the solvent to mix with ink. If upon re-checking the viscosity of the ink in mixer tank 17 the viscosity is still above the upper threshold value then more solvent may be added to the mixer tank 17 from solvent reservoir 20 in solvent tank 19. This process may be repeated until a desired viscosity of ink in mixer tank 17 is reached.

Solvent tank 19 is provided with a level sensor (not shown) that is operable to determine a level of solvent in the solvent tank 19 and output a signal indicative thereof to controller 4. Solvent is consumed during operation of the printer 1 as it is added to the mixer tank 17 to adjust the viscosity of the ink in reservoir 18. Therefore the level of solvent in the solvent reservoir 20 in solvent tank 19 falls over time.

When the level of solvent in the solvent tank 19 falls below a lower threshold, the controller 4 is operable to control the ink supply system 2 so as to add more solvent to the solvent tank 19. Using suitable control signals, valves 48, 49 in the service module 6 are opened. Solvent is drawn from solvent cartridge 10 by electric flush pump 47 in the service module 6 and is supplied through line 62 to the solvent reservoir 20. The solvent discharges into the solvent reservoir 20, increasing the level.

When the level of solvent in the solvent tank 19 reaches an upper threshold the controller 4 is operable to stop the supply of solvent to solvent tank 19. To achieve this, flow to flush pump 47 is stopped and valves 48, 49 are closed.

Following such a process of topping up the level of solvent in solvent tank 19, the controller 4 sends a signal to data storage device 13 on solvent cartridge 10 indicative of the quantity of solvent that has been transferred from the cartridge 10 to the solvent tank 19. A quantity of solvent remaining in the solvent cartridge 10 may be stored on the data storage device 13 and may be updated in response to the signal from the controller 4.

Make-up solvent, provided from the solvent cartridge 10, is also used to flush the print head 3 at appropriate times To keep it clear of blockages, as now described. Ink is drawn from the mixer tank 17 and delivered under pressure to venturi pump 23 to create a suction pressure at the side port 42. Solvent is drawn from solvent cartridge 10 by electric flush pump 47 in the service module 6 and is supplied through a flush line 54 to the print head 3 via filter 55. Flow of solvent from the service module 6 to the print head 3 is controlled by first control valve 31.

A pressure relief valve 56 is connected across the inlet and outlet of the flush pump 47 and acts to relieve excess pressure to the suction side of the flush pump 56. For example, pressure relief valve 56 may be arranged to maintain a desired pressure downstream of the flush pump 47, for example 2.5 bar.

The solvent flows through the first control valve 31 to the nozzle 32. After passing through the nozzle 32 and into the gutter 36 the solvent (along with dissolved ink from the print head 3) is drawn into the return line 37 under suction pressure from the venturi pump 23. The solvent and ink discharge into the mixer tank 17.

As explained above, flow of ink and solvent into mixer tank 17 is achieved using venturi pump 24, which requires a minimum quantity of fluid in mixer tank 17. If there is insufficient fluid in the mixer tank 17 for operation of the venturi pump 24 (e.g. before a first use of the ink supply system 2), the flush pump 47 in service module 6 can be used to prime the mixer tank 17 by adding fluid to it.

To prime the mixer tank 17, an ink cartridge is engaged with the solvent cartridge connection 9. To add ink to the mixer tank 17, valves 48, 50 in the service module 6 are opened. Ink is drawn from an ink cartridge (in the solvent cartridge connection 9) by electric flush pump 47 in the service module 6 and is supplied through supply line 44 to the mixer tank 17 via side port 42. Once a sufficient quantity of ink has been added to the mixer tank 17, flush pump 47 is stopped and valves 48, 50 are closed.

In use, the atmosphere in the mixer tank 17 and the solvent tank 19 can become saturated with solvent. A condenser unit 57 is provided in an upper portion of the solvent tank 19. Condenser unit 57 may, for example, include a Peltier-type condenser.

A ventilation tube 58 is provided between the mixer tank 17 and the solvent tank 19 to allow air to flow therebetween. The ventilation tube 58 is arranged such that it links a space above the reservoir of ink 18 to a space above the reservoir of solvent 20. Solvent-laden vapor from the mixer tank 17 enters the solvent tank 19 via ventilation tube 58. The air from the mixer tank 17 is warmer than the air in the solvent tank (due to the action of the system pump 21), and therefore it rises to the top of the solvent tank via ventilation tube 58, where it enters the condenser unit 57.

Solvent condenses as the air contacts an active element within the condenser unit 57 and is cooled. The condensate (solvent) drains into the solvent reservoir 20. The dried air (from which the solvent has been removed) enters the common port of a three-way control valve 59. The flow of air through the system can be controlled using control valve 59, as now described.

The dried air from the condenser unit 57 may flow through exit line 60, via which it is vented to the air space inside the printer cabinet 16. This air flow path may be a default configuration for control valve 59.

Alternatively, the dried air from the condenser unit 57 may flow through line 61 which passes through the umbilical conduit 15 to the print head 3. Line 61 terminates in the print head 3 at return line 37, near the gutter 36. Vacuum pressure draws the vented air along the return line 37 towards the second control valve 38 (along with any ink entering the gutter 36). Normal operation of venturi pump 23 draws the unused ink drops and vented air along the return line 37, through the umbilical conduit 15 and back to side port 42. The unused ink and vented air are both discharged into the mixer tank 17.

When control valve 59 is used to direct the dried air from the condenser unit 57 through line 61, a ‘closed’ hydraulic loop is created. Any solvent vapor which is not recovered by the condenser unit 57 passes back to the mixer tank 17 via lines 61, 32 and loss of solvent from the inkjet printer 1 is therefore minimized. The system recirculates the same air continuously, which prevents (or at least minimizes) the influx of ambient air, which would otherwise enter via the gutter 36 (e.g. if the control valve 59 is venting the dried air from the condenser unit 57 to the air space inside the printer cabinet 16 via exit line 60). This preclusion of ambient air entering the system helps to prevent oxygen ingestion via the gutter 36, which promotes improved ink performance over the long term by reducing the probability of ink oxidation.

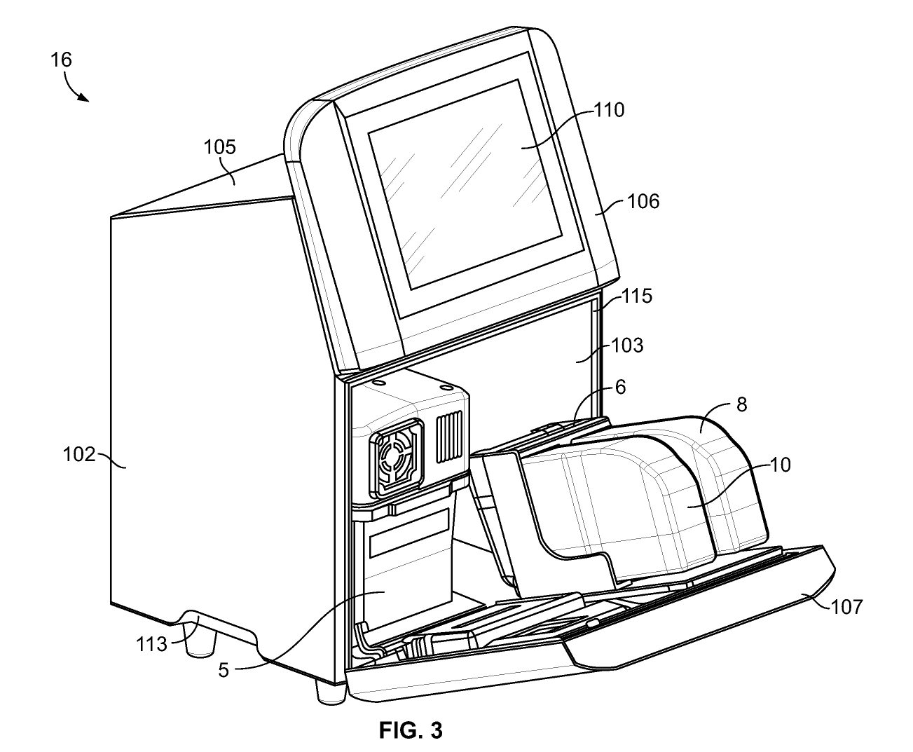

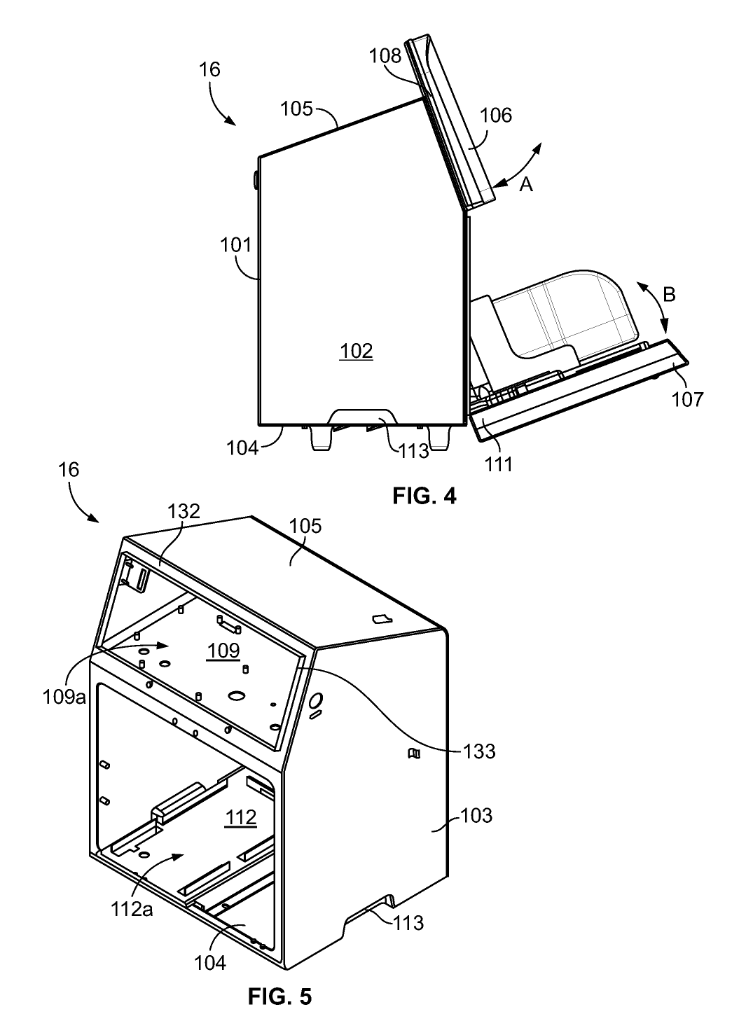

FIGS. 3 and 4 show perspective and side views respectively of an embodiment of the cabinet 16 for inkjet printer 1. Cabinet 16 has been adapted to minimise ingress of matter into an interior of the cabinet 16 and to reduce opportunities for matter to collect on an exterior of the cabinet, as described below. This makes the cabinet 16 particularly suitable for use in hygienic environments such as food production environments.

Cabinet 16 has a rear wall 101, side walls 102, 103, a base 104 and a top 105. Rear wall 101, side walls 102, 103, base 104 and top 105 may be considered to form a housing.

A front of the cabinet 16 is provided with an upper door 106 and a lower door 107 each of which is pivotally attached to the housing. FIG. 5 shows the housing of the cabinet 16, i.e. with the upper and lower doors 106, 107 removed.

Upper door 106 is pivotally attached to the housing such that it can rotate relative thereto about a pivot 108 generally as indicated by arrow A. The upper door 106 provides access to an upper compartment 109. The upper door 106 is operable to rotate between at least a closed position (see FIGS. 3 and 4) and an open position. When in the open position, access to the upper compartment 109 is provided via a generally rectangular aperture 109a. When in the closed position, upper door 106 blocks access to the upper compartment 109.

Upper compartment 109 contains control circuitry (not shown) which may form part of the controller 4. A display screen 110 is provided on the upper door 106. Display screen 110 may be operable to display information relating to the inkjet printer 1 for a user to access. The display screen 110 may be a touch screen and may provide a user input device allowing a user to control one or more parameters of the inkjet printer 1. Alternatively, a separate user input device (not shown) may be provided on upper door 106.

Lower door 107 is pivotally attached to the housing such that it can rotate relative thereto about a pivot 111 generally as indicated by arrow B. The lower door 107 provides access to a lower compartment 112 of the housing. The lower door 107 is operable to rotate between at least a closed position and an open position (see FIGS. 3 and 4). When in the open position, access to the lower compartment 112 is provided via a generally rectangular aperture 112a. When in the closed position, lower door 107 blocks access to the lower compartment 112.

In use, elements of the ink supply system 2 are disposed within the lower compartment 112. Service module 6, ink cartridge 8 and solvent cartridge 10 are attached to the lower door 107. Ink storage system 5 is disposed in the housing and may, for example, be attached to the base 104 of the cabinet 16.

The cabinet 16 may be used in a food preparation environment. It is therefore desirable to reduce opportunities for matter to collect on an exterior of the cabinet 16 for reasons of hygiene. In use, the cabinet 16 may be mounted on a stand (not shown) and may be orientated such that the base 104 is generally horizontal. Furthermore, the cabinet 16 may be cleaned periodically by being hosed down to ensure food hygiene standards are met. For example, when a production line is used for the preparation of more than one foodstuff all equipment on the production line (including inkjet printer 1) may be hosed down between preparation of two different foods on the production line. This can reduce contamination of the second food by the first food.

The top 105 of the cabinet 16 is inclined relative to the base 104. The top 105 is therefore disposed at a non-zero angle relative to the base 104. Furthermore, the housing is shaped such that when the upper door 106 is in the closed position it is inclined relative to the base 104. Therefore, when closed the upper door 106 is disposed at a non-zero angle relative to the base 104. Therefore, in use, when the base 104 is horizontal the top 105 and upper door 106 (when in the closed position) are not. This reduces collection of matter (such as, for example, food debris from a production line) on the cabinet 16 since such matter will tend to slide off the inclined surfaces formed by the top 105 and upper door 106. Furthermore, the inclination of the top 105 and upper door 106 relative to base 104 aids drainage of water or other cleaning fluids from the cabinet 16 when it is being hosed down, preventing cleaning fluid (potentially containing food debris) from pooling on a surface of the cabinet 16.

The cabinet 16 is not provided with an external lifting handle but rather is provided with a recess 113 on each side of the cabinet 16 at an edge between each side wall 102, 103 and the base 104. The recesses 113 are for use as a handhold. A user can insert a hand into each recess 113 when it is desired to lift the cabinet 16. Again, such an arrangement avoids the provision of any upwardly facing horizontal surfaces (as would be provided by an external handle) on which matter could collect or cleaning fluids could pool.

To minimize ingress of matter into the cabinet 16 each of the upper and lower doors 106, 107 is provided with an internal hinge and a sealing member, as now described.

As can be seen most clearly in FIG. 5, the aperture 112a to the lower compartment 112 does not extend from side wall 102 to side wall 103. Rather, a lower front wall section 114 is provided around the perimeter of the aperture 112a. The cabinet 16 is provided with a sealing member 115 (shown in FIG. 3) around the perimeter of the aperture 112a, the sealing member 115 engaging with the lower front wall section 114.

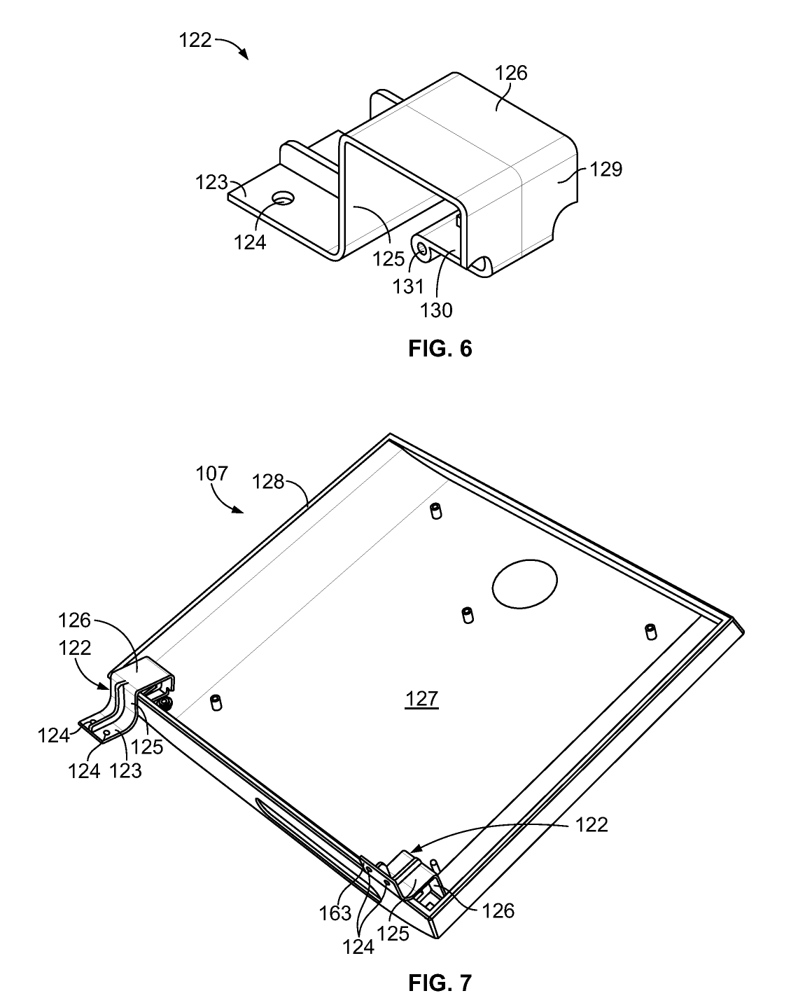

The cabinet 16 includes two lower hinges (described in more detail below with reference to FIGS. 6 and 7) which form the pivotal attachment between the housing of the cabinet 16 and the lower door 107. Each of the lower hinges includes a bracket 122 which is fixed to the base 104 of the cabinet 16 and to which the lower door 107 is pivotally attached.

FIG. 6 shows one of the brackets 122 and FIG. 7 shows both brackets 122 pivotally attached to the lower door 107. Each bracket 122 defines a generally flat section 123 for attachment to the base 104 of the cabinet 16. For this purpose, generally flat section 123 is provided with fixing apertures 124 to allow generally flat section 123 to be fixed to the base 104. A second section 125 extends away from generally flat section 123 (and the base 104 when fitted) to a third section 126.

The lower door 107 of the cabinet 16 includes a front panel 127 and a peripheral rim 128. The front panel 127 extends generally across aperture 112a when the lower door 107 is in the closed position. The peripheral rim 128 extends around the perimeter of the front panel 127, extending away from and generally perpendicular to the front panel 127 so as to form a recess.

The third section 126 of bracket 122 extends away from the housing of the cabinet 16 and into the recess defined by the lower door 107, when the lower door 107 is in the closed position. A fourth portion 129 extends from the third portion 126 such that it is generally parallel to the second portion 125. The fourth portion 129 is shorter than the second portion 125. A fifth portion 130 is generally parallel to the third section 126 and extends from the fourth section 129 towards the second section 125. A distal end of the fifth portion 130 is provided with a through bore 131 for receipt of a hinge pin (not shown). The fifth portion 130 is shorter than the fourth portion 129.

Pivotal attachment of the brackets 122 to the lower door 107 is by way of two hinge pins (not shown), each of which is received within one of the through bores 131. The hinge pins are fixed relative to the lower door 107 by a bracket or support (not shown). In FIG. 7, the left hand bracket 122 is disposed in a first orientation relative to the lower door 107 and the right hand bracket 122 is disposed in a second orientation relative to the lower door 107. When the lower door 107 is in the open position, both brackets 122 are disposed in the first orientation and when the lower door 107 is in the closed position, both brackets 122 are disposed in the second orientation.

The through bores 131 of the two brackets 122 are generally aligned with the pivot 111 (see FIG. 4). The brackets 122 extend from the base 104 of the cabinet 16 and into the recess defined by the lower door 107 such that the pivot 111 is inside the recess of the lower door 107. With such an arrangement, all parts of the hinge are within the cabinet 16 when the door is in the closed position, allowing a seal to be formed between the housing and the lower door 107 around the entire perimeter of the lower door 107 by the sealing member 115.

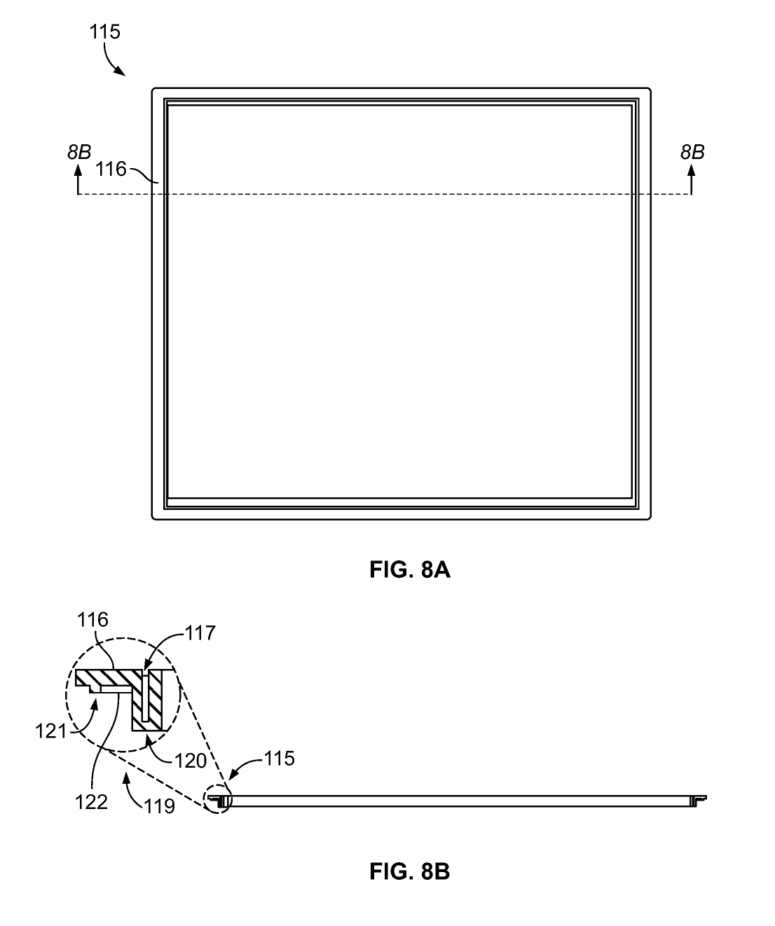

The sealing member 115 is show in FIGS. 8A and 8B. As can be seen more clearly in the sectional view of FIG. 8B, sealing member 115 includes a rear surface 116 which engages with the lower front wall section 114. The sealing member 115 may be connected to, or may engage with, the lower front wall section 114 in any convenient way. In one embodiment, the sealing member 115 may be adhered to the lower front wall section 114 by a suitable adhesive. In another embodiment a flange (not shown) may be provided on the lower front wall section and the flange may be received within a groove 117 on the rear surface 116. For such embodiments engagement of the sealing member 115 with the lower front wall section 114 may be similar to the corresponding engagement of another sealing member (sealing member 135, described below) with the cabinet 16.

A front 119 of the sealing member 115 is arranged to engage with the lower door 107 when the lower door 107 is closed. To achieve an effective seal, the sealing member 115 is provided with a first thicker portion 120 for receipt within the recess of lower door 107 and a second thinner portion 121 for engaging the peripheral rim 128 of the lower door 107. The second portion 121 defines a groove 122 for receipt of the peripheral rim 128 of the lower door 107.

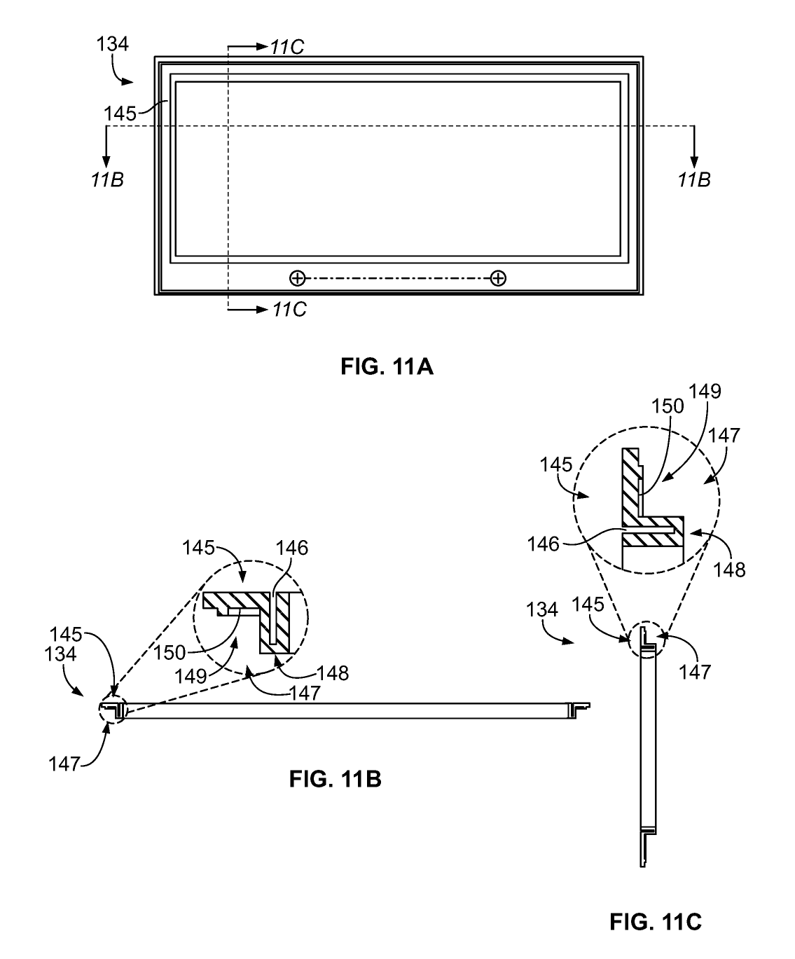

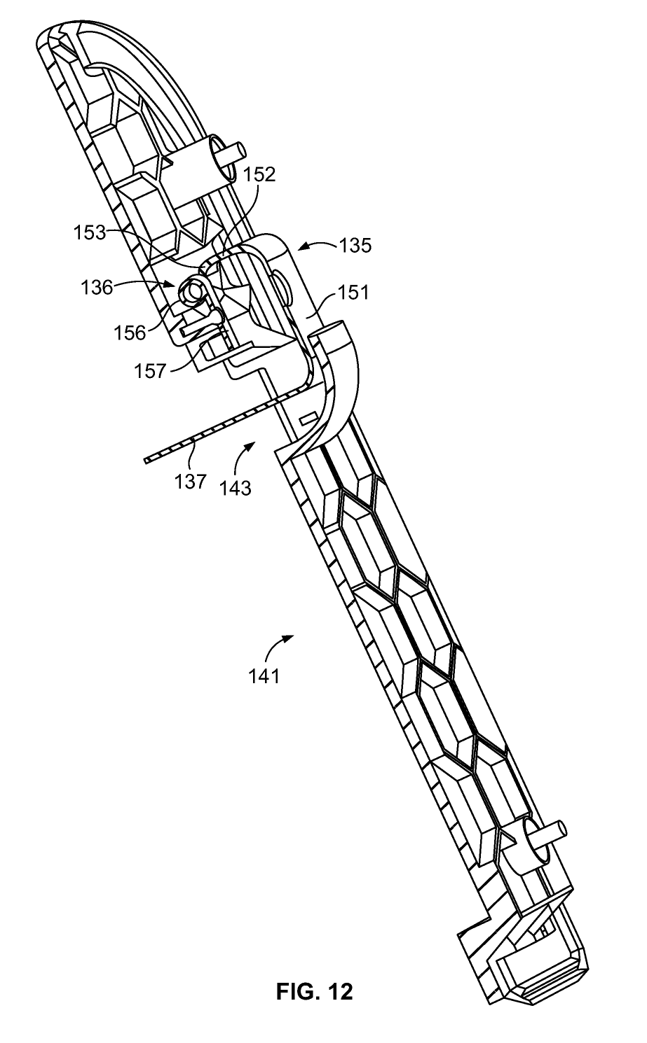

Referring again to FIG. 5, the aperture 109a of the upper compartment 109 does not extend from side wall 102 to side wall 103. Rather, an upper front wall section 132 is provided around the perimeter of aperture 109a. A flange 133 extends around the perimeter of aperture 109a. The flange 133 extends away from and generally perpendicularly to upper front wall section 132. The cabinet 16 is provided with a sealing member 134 (described in more detail below with reference to FIGS. 11A to 11C) around the perimeter of the aperture 109a, the sealing member 134 engaging with the upper front wall section 132.

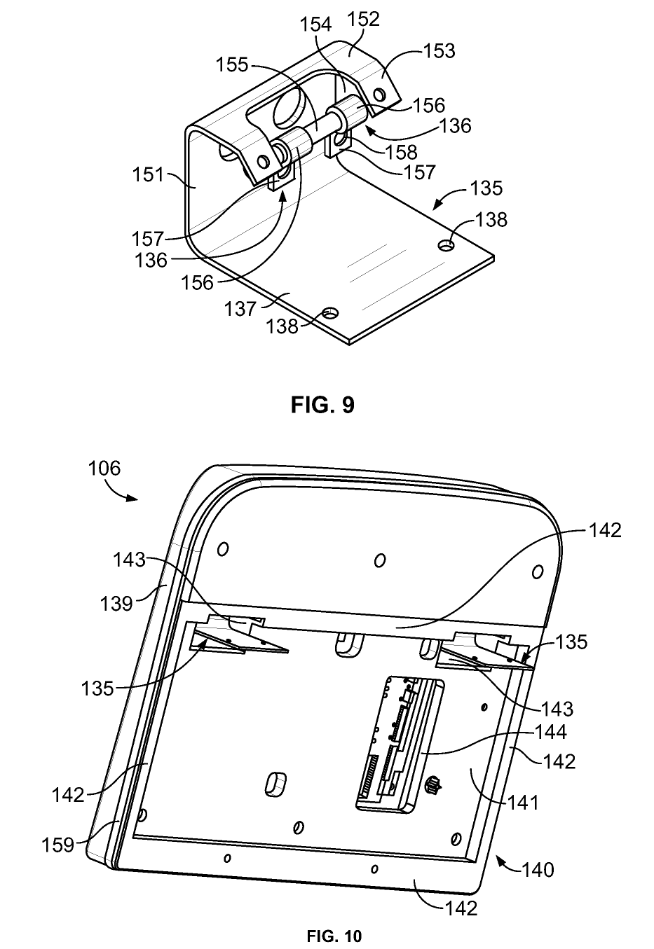

The cabinet includes two upper hinges which form the pivotal attachment between the housing of the cabinet 16 and the upper door 106. Each of the upper hinges includes a first bracket 135 and a pair of second brackets 136, as shown in FIG. 9. Each of the pair of second brackets 136 is pivotally attached to the first bracket 135. The first bracket 135 is fixed to the top 105 of the cabinet 16. Each of the pair of second brackets 136 is fixed to the upper door 106.

As shown in FIG. 10, the upper door 106 includes a housing 139 for various control electronics. A rear panel 140 of the housing 139 includes a recessed portion 141, the recessed portion being defined by raised portions 142. Two apertures 143 are provided in the recessed portion 141 of the rear panel 140. The first brackets 135 are fixed to the top 105 of the cabinet 16 and each extends from the top 105 of the cabinet 16 and into the housing 139 of the upper door 106 through one of the apertures 143. As a result, the pivot 108 is inside the housing 139 of the upper door 106. One or more additional apertures 144 are provided in rear panel 140 to provide access to the housing 139 from the upper compartment 109 and/or to allow electrical cables or the like to pass between the housing 139 and the upper compartment 109.

The sealing member 134 is show in FIGS. 11A to 11C. As can be seen more clearly in the sectional views of FIGS. 11B and 11C, sealing member 134 includes a rear surface 145 which engages with the upper front wall section 132 and the flange 133 around the perimeter of the aperture 109a. A groove 146 is provided on rear surface 145, the groove 146 extending around the perimeter of the sealing member 134. The flange 133 is received in the groove 146 such that the rear surface 145 of the sealing member 134 contacts the upper front wall section 132 of the housing.

A front 147 of the sealing member 134 is arranged to engage with the upper door 106 when it is closed. To ensure a reliable seal, the front 147 is provided with a first thicker portion 148 for receipt within the recess 141 on the rear plate 140 of the upper door 106 and a second thinner portion 149 for engaging the raised portions 142 of the rear panel 140. The second portion 149 defines a groove 150 for receipt of the raised portions 142 of the rear panel 140.

The rear panel 140 of upper door 106 extends generally across the aperture 109a when the upper door 106 is closed.

Referring again to FIG. 9, the first bracket 135 defines a generally flat section 137 for attachment to the base 104 of the cabinet 16. For this purpose, the generally flat section 137 is provided with fixing apertures 138 to allow the generally flat section 137 to be fixed to the top 105 of the cabinet 16.

The generally flat section 137 of the first bracket 135 extends away from the housing of the cabinet 16 and into the housing 139 of the upper door 106, when upper door 106 is in the closed position.

A second section 151 of the first bracket 135 extends away from the generally flat section 137 and is generally perpendicular to the generally flat section 137. A third section 152 extends from the second section 151 such that it is generally parallel to the generally flat section 137. The third section 152 is shorter that the generally flat section 137. A fourth section 153 extends from the third section 152. A cut away section 154 extends through the fourth section 153 and partially through the third section 152 such that the fourth section 153 includes two separate portions. A hinge pin 155 extends between the two separate portions of the fourth section 153.

Each of the pair of second brackets 136 is generally p-shaped in cross section, including a loop section 156 and a generally flat section 157 extending therefrom. The hinge pin 155 extends through the loop section 156 of each of the pair of second brackets 136 such that each of the pair of second brackets 136 is pivotally connected to the first bracket 135.

The generally flat section 157 of each of the pair of second brackets 136 is attached to an interior face of rear plate 140 via fixing apertures 158. The loop sections 156 of the second brackets 136 of both upper hinges are generally aligned with the pivot 108 (see FIG. 4). Since the first brackets 135 extend from the top 105 of the cabinet 16 and into the housing 139 of the upper door 106, the pivot 108 is inside the housing 139.

With such an arrangement, all parts of the upper hinges are within the cabinet 16 when the upper door 106 is closed, allowing a seal to be formed between the housing and the upper door 106 around the entire perimeter of the aperture 109a by the sealing member 134.

As shown in FIG. 10, an additional sealing member 159 is provided in a groove which extends around the perimeter of the housing 139 of the upper door 106. The sealing member 159 provides an additional seal between the upper and lower doors 106, 107 when they are both closed.

Each of the sealing members 115, 134, 159 may be formed from any suitable material of a suitable hardness. Suitable materials include rubber, silicone or the like. The rubber may be a synthetic rubber, for example, EPDM rubber (ethylene propylene diene monomer (M-class) rubber). Suitable materials may have a Shore hardness of around 50 or 60. In one embodiment, sealing member 115 is formed from EPDM 50 Shore, sealing member 134 is formed from silicone 60 Shore and sealing member 159 is formed from silicone 60 Shore.

The above-described cabinet 16 for the inkjet printer 1 provides an arrangement with two doors 106, 107, each of which is provided with an internal hinge and a sealing member 115, 134 that extends around the entire perimeter of its respective door 106, 107. Furthermore, an additional sealing member 159 is provided at an interface between the two doors. Such an arrangement minimizes ingress of matter into an interior of the cabinet 16.

In use, the cabinet 16 may be used in a hygienic environment such as a food production environment. It may be desired or required for all equipment within such an environment to have a given Ingress Protection (IP) rating, which specifies what level of protection is provided against ingress of solids and liquids (such as water). An ink jet printer 1 for use in such an environment may be required to have the required IP rating. The features of the above disclosed cabinet 16 may therefore be adapted so as to provide a desired IP rating for use in an industrial environment such as, for example, IP65, IP66 or IP55.

Furthermore, the above-described cabinet 16 for the inkjet printer 1 provides an arrangement which minimizes the opportunities for matter to collect on an exterior surface of the cabinet 16 since upwardly facing horizontal surfaces have been avoided. This is achieved by an arrangement wherein: (a) the top 105 is inclined relative to the base 104; the housing is shaped such that when the upper door 106 is closed it is inclined relative to the base 104; and (c) the provision of the recesses 113 as opposed to external lifting handles.

The above-described cabinet 16 is particularly suitable for use in hygienic environments such as food production environments.

While specific embodiments of the invention have been described above, it will be appreciated that the invention may be practiced otherwise than as described. The description is not intended to limit the invention.

1. An inkjet printer cabinet for use in a hygienic environment, the cabinet comprising a housing formed by a base, a top and one or more walls extending between the base and the top, the housing defining an interior configured for receipt of components of an inkjet printer, the housing defining an apertures, the aperture providing access to at least one of the components via the aperture, the housing incorporating one or more features adapted to reduce at least one of the accumulation of unwanted matter on a surface of the housing and the accumulation of unwanted matter within the interior of the housing.

2. The inkjet printer cabinet of claim 1 wherein the top is disposed at a non-zero angle to the base.

3. The inkjet printer cabinet of claim 1 comprising at least one handle, wherein the at least one handle is provided by a recess at an edge between the one or more walls and the base.

4. The inkjet printer cabinet of claim 1 further comprising at least one door, the at least one door being pivotally connected to the housing and movable about a pivot between at least a closed position wherein it blocks access to a corresponding one of the one or more apertures and an open position wherein the corresponding aperture is accessible.

5. The inkjet printer cabinet of claim 4 wherein the housing is shaped such that the at least one door is disposed at a non-zero angle to the base when disposed in its closed position.

6. The inkjet printer cabinet of claim 4 wherein each of the doors is provided with an internal hinge.

7. The inkjet printer cabinet of claim 6 wherein the internal hinge is arranged such that the pivot of the door is disposed within a recess or a housing of the door.

8. The inkjet printer cabinet of any one of claim 4 further comprising a sealing member around a perimeter of the aperture, the sealing member for providing a seal between the housing and one or the one or more doors.

9. The inkjet printer cabinet of any one of claim 4 comprising two doors and further comprising a sealing member provided on one or both of the two doors arranged to provide a seal between the two doors when they are both in their respective closed positions.

10. An ink jet printer comprising the inkjet printer cabinet of claim 1.

11. The ink jet printer of claim 10 further comprising:
a print head;
an ink supply system; and
a controller operable to provide control signals to the print head and the ink supply system so as to control the flow of ink and solvent through the inkjet printer, wherein the ink supply system and/or the controller is at least partially housed within the cabinet.

12. The ink jet printer of claim 10 wherein the ink jet printer is a continuous inkjet printer.
